(19) United States
(12) Patent Application Publication
(10) Pub. No.: US 2003/0178515 A1
(43) Pub. Date: Sep. 25, 2003

(54) System and method of monitoring a crushing device

(76) Inventors: Johannes I. Boerhout, San Diego, CA (US); Andre Du Bruyn, Cinda Park (ZA); Keith Meyers, Collegeville, PA (US); Abie Struass, Ontdekker Park (ZA); George Voloskin, Del Mar, CA (US); Matt Yeknilk, Phoenix, AZ (US); Karel Nathalis Vermeiren, Velddriel (NL)

Correspondence Address: KNOBBE MARTENS OLSON & BEAR LLP, 2040 MAIN STREET, FOURTEENTH FLOOR, IRVINE, CA, 92614, US

(21) Appl. No.: 10/090,097

(22) Filed: Feb. 28, 2002

Related U.S. Application Data
(60) Provisional application No. 60/272,752, filed on Mar. 1, 2001.

(51) Int. Cl. B02C 25/00

(52) U.S. Cl. 241/30; 241/101.4

(57) ABSTRACT

A monitoring system for a crushing device that provides continuos and automatic monitoring. In one embodiment of the invention, the monitoring system monitors vibration signals and sensed temperature readings to determine whether the sensed data exceeds predefined thresholds and thereby signaling an possible alarm condition. In the event of the alarm condition, an idle detector in the monitoring system determines whether the crushing device is operating in an idle state. If the crushing device is in an idle state, an alarm is signaled for operator attention and optionally the crushing device may be automatically shutdown. The monitoring system may be used with any crushing device such as cone crushers, roll crushers, jaw crushers, and impact crushers or other type crushing devices.

### RELATED APPLICATIONS

This Application claims priority to and incorporates by reference, in its entirety, U.S. Provisional Application No. 60/272,752, Filed Mar. 1, 2001.

### BACKGROUND OF THE INVENTION

1. Field of the Invention

The field of the invention relates to crushing devices. More particularly, the field of the invention relates to a system and method of monitoring a crushing device.

2. Description of the Related Technology

Vibration monitoring of crushing devices, e.g., a jaw crusher or a cone crusher, has been proven to be a good diagnostic tool for identifying possible faults in the operation of the crushing device. For known systems, it is common practice to manually monitor the vibration generated by the device on a periodic basis. For example, once every week, month, or other time period, the crushing device is removed from operation, and it is run in an “idle” state. During this time, vibration levels of the crushing device are tested to see if they exceed predetermined thresholds.

One problem with the foregoing approach is that the crushing device often operates for a significant period of time before a fault in the crushing device is detected. During such time, the fault may cause significant damage to the crushing device and result in less than optimal performance. Furthermore, such an approach requires manual intervention and testing which can significantly increase the cost of monitoring the crushing device.

Consequently, there is a need for a system to monitor and detect faults of crushing equipment proximate in time to the occurrence of the fault. The system should also not require frequent manual intervention and testing of the crushing equipment.

### SUMMARY OF THE INVENTION

One aspect of the invention comprises a crushing system. The crushing system comprises a crushing device that is configured to crush a material. The crushing device can include any crushing device, such as is selected from the group comprising, but not limited to: a cone crusher, a jaw crusher, an impact crusher, and a roll crusher. The crushing system also comprises a first detector configured to detect vibration signals from the crushing device and configured to identify fault conditions based upon the detected vibration signals. The fault detection system can optionally be configured to include temperature monitoring. The crushing system also comprises a second detector configured to detect an idle state of the crushing device.

Another aspect of the invention comprises a first detector configured to detect an idle state of the crushing device. The first detector is selected from the group comprising, but not limited to: a level switch, a mechanical indicator switch on a feed conveyor, a detector for detecting vibration signals from the crushing device, and a detector for determining a current that is provided to the crushing device. The crushing system may also comprise a second detector configured to detect vibration signals from the crushing device, a third detector configured to detect a temperature of at least one area of the crushing device, and an alarm to alert the crusher user for identifying during the detected idle state when either the vibration signals exceeds a selected threshold or when the temperature exceeds a selected threshold.

Another aspect of the invention comprises a method of monitoring crushing equipment. The method comprises detecting an idle state of a crushing device. During the detected idle state, faults of the crushing device are identified.

Yet another aspect of the invention comprises a system for monitoring a crushing device. The system comprises means for detecting an idle state of a crushing device, means for detecting a vibration level of the crushing device, means to monitor temperature of the crushing device, and means for determining, subsequent to the detection of an idle state, whether the detected vibration signals or optionally high temperature indicate a fault in the crushing device. During the detected idle state, faults of the crushing device can be detected.

### BRIEF DESCRIPTION OF THE DRAWINGS

FIG. 1 is a block diagram illustrating one exemplary embodiment of a monitoring system for a crushing device.

FIG. 2 is a flowchart illustrating one embodiment of the method of operation of the monitoring system of FIG. 1.

FIGS. 3A, 3B, 3C, 3D are each representational block diagrams of a selected type of crushing device.

### DETAILED DESCRIPTION OF EMBODIMENTS OF THE INVENTION

The following detailed description is directed to certain specific embodiments of the invention. However, the invention can be embodied in a multitude of different ways as defined and covered by the claims.

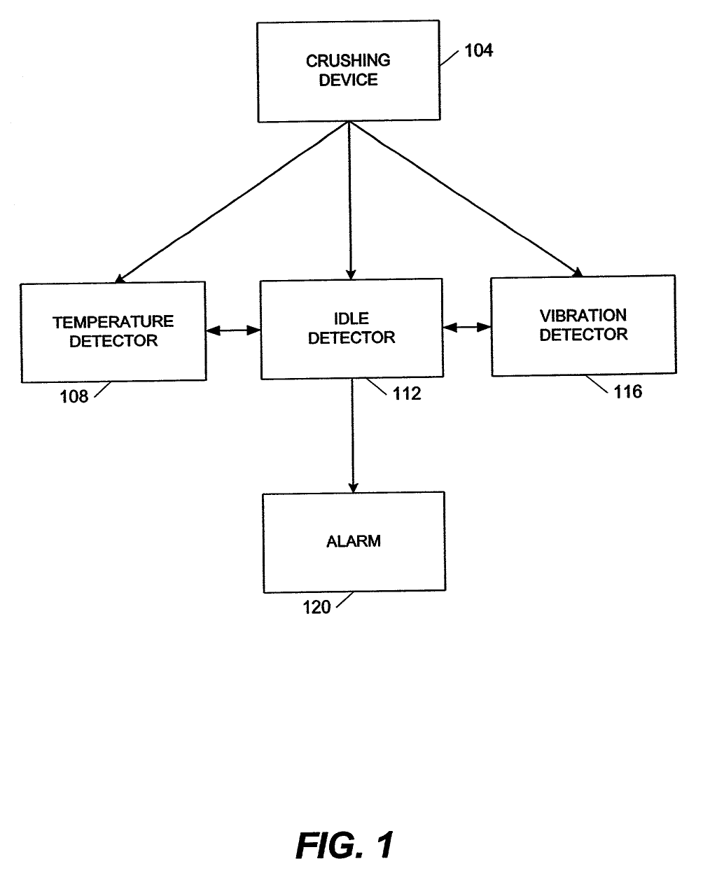

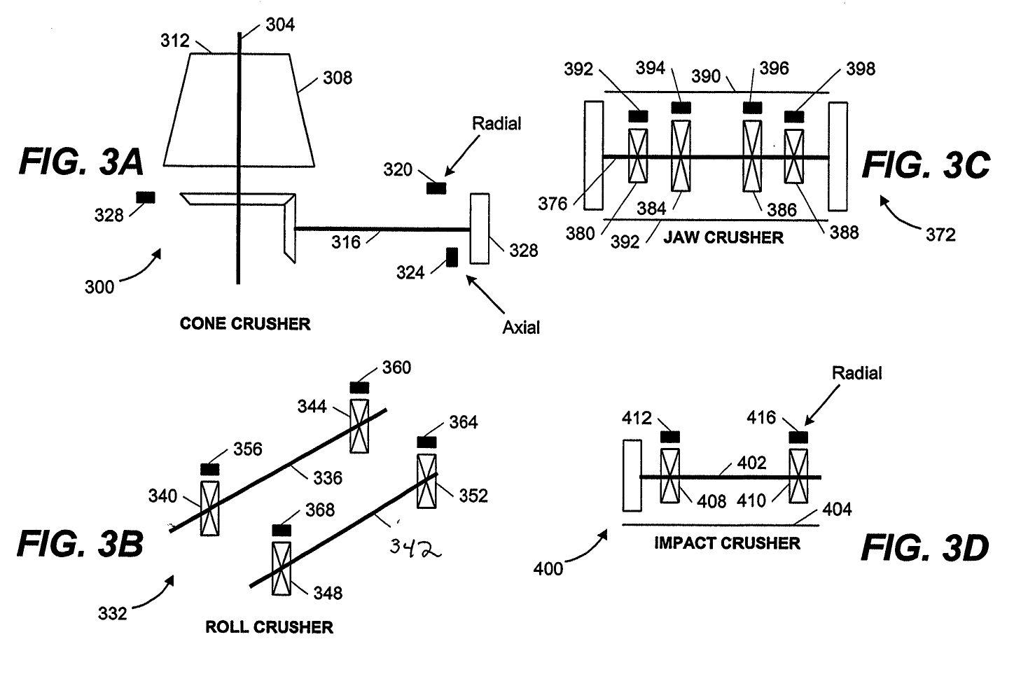

FIG. 1 is a block diagram illustrating one exemplary embodiment of a monitoring system for a crushing device 104. The crushing device 104 can include any machinery that is used for the crushing of materials. Exemplary crushing devices include a cone crusher, a jaw crusher, a roll crusher and an impact crusher. See, e.g., FIG. 3.

One function of the crushing device 104 is to reduce the size of a material. The crushing device 104 crushes the material by compressing the material between two surfaces or by impaling the material onto a hard surface. The vibration level in the crushing device 104 temporarily increases when the crushing device 104 crushes material owing to the nature of the crushing phenomenon. Depending on the particular manufacture and type of the crushing device 104, the vibration level can increases 5 to 10 times or more the vibration values to the vibration values monitored during idling. The vibration level reduces back to the idle level a short time interval after all the intended material has passed through the crushing device 104.

The monitoring system of the crushing device 104 provides automatic and continuous monitoring of the vibrations that emanate from the crushing device 104 during every idle state of operation of the crushing device 104. In one embodiment of the invention, the monitoring system performs certain fault analysis of vibration signals and temperature data that is provided sensors in the crushing device only during detected idle states. This advantageously prevents misdiagnosing faults because of noise generated during the crushing operation of the crushing device.

In one embodiment of the invention, the monitoring system of the crushing device 104 includes a temperature detector 108, an idle detector 112, a vibration detector 116, and an alarm 120. The vibration detector 106 detects faults in the components of the crushing device 104 before the magnitude of fault results in significant damage of the crushing device 104 and before the occurrence of secondary damage or catastrophic machine shutdown. The vibration detector 106 can detect faults in the crusher such as, but not limited to “looseness” of components, inadequate lubrication and contaminated lubrication of components, such as the bearings, in the crushing device 104, damaged bearings and gears, motor faults, and in some cases unbalanced rotors.

Typical vibration levels in a crushing device 104 not having any internals faults (bad bearings for instance) while idling are in the usual range of 1 to 15 gE3. When a fault occurs in the crushing device, the vibration level increases. In one embodiment of the invention, the vibration monitoring for these faults are made in the frequency range of 200 to 12 kHz. An increase in the demodulated acceleration spectrum within this range can identify repetitive high frequencies that are indicative of mechanical faults. Some crushers, like the impact crusher, whose shafts rotate at higher speed can be subject to mechanical unbalance due to non-uniform wear of the rotor. This change in rotor unbalance can be detected using a change velocity spectrum in the range of 10 Hz to 10 kHz.

Depending on the embodiment, the idle detector 112 can utilize one or more of a number of different devices to detect an idle state. In one embodiment of the invention, the idle detector 112 analyzes and filters the vibrations signals that are generated as a result of the operation of the crushing device 104. In this embodiment, the idle detector 112 monitors the average of the vibration signals. The average of the vibration signals tends to fall within certain ranges depending on the type of activity that is being performed by the crushing device, even in the presence of faults in the crushing device. If the crushing device 104 is idling, the average of the vibration signals fall within a selected idling range.

Furthermore, the idle detector 112 detects an idle state by using an infra-red, optic, or ultrasonic level indicator to indicate the presence of material in the crushing device 104. The idle detector 112 can also detect an idle state via the use of mechanical indicator switches on a feed conveyor or feed bin of the crushing device 104. Additionally, the idle detector can employ a signal from a detector that measures the mass (weight) of material in the crusher feed mechanism. When a switch indicates that there is no material being provided to the crushing device, the idle detector 112 senses that the crushing device 104 is in an idle state. For example, when a feed bin flap (assuming one is present) of the crush detector 104 is detected to be shut (or closed), it is determined that the crushing device 104 is in an idle state.

The idle detector 112 may also monitor the current or power that is provided to the crushing device 104. For example, a current transformer and current sensing relay can be used to monitor the current of a motor in the crushing device 104. If the current increases, the idle detector 112 senses that the current has increased above a certain threshold, then the idle detector 112 assumes that the crushing device 104 is in operation. However, if the current or power decreases, the idle detector 112 senses that the crushing device 104 is in an idle state. In all cases, a time delay sequence may also be used to avoid false alarms from stray material entering the crushing device causing momentary high vibration and false alarms.

The temperature detector 108 detects the temperature of various components of the crushing device. The temperature detector 108 and/or the vibration detector 116 can be in wire or wireless connection with various temperature sensors that are located in, on, or near selected components, such as the bearings of the crushing device 104.

The alarm 120 provides an audio or visual alarm indicating the occurrence of a fault in the crushing device 104. In one embodiment of the invention, the alarm 120 is signaled when a fault causes the vibration levels of the crushing device 104 1.5 to 2 times the normal vibration level during the idling state.

Depending on the embodiment, various components of the monitoring system can be integrated into a single component. For example, the alarm 120 and the idle detector 112 can be integrated into a unitary unit.

Furthermore, it is to be appreciated that selected components of the temperature detector 108, the idle detector 112, and the vibration detector 116 can be integrated with the crushing device 104, or alternatively, manufactured and sold as separate components. For example, in one embodiment, the temperature detector 108, the idle detector 112, and the vibration detector 116 are all manufactured in a control component of the crushing device 104.

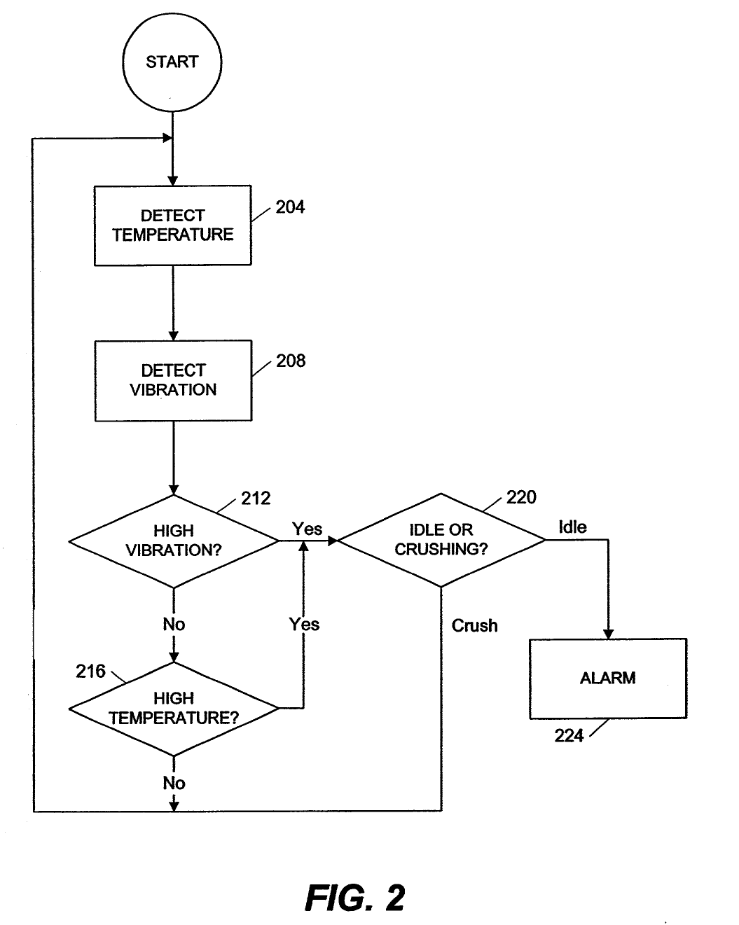

FIG. 2 is a flowchart illustrating one embodiment of the method of operation of the monitoring system of FIG. 1. Depending on the embodiment, additional steps may be added, others removed, and the ordering of the steps rearranged. Furthermore, depending on the embodiment, one or more of the steps may be integrated into a single step and/or the one or more of the steps may actually occur in a series of steps.

Before starting at a state 204, the crushing device 104 is activated so it is ready to receive material for crushing. Periodically, material is provided to the crushing device 104 for crushing. FIG. 2 generally describes a process of providing continuous and automatic monitoring of the crushing device 104 so as to detect a fault when the crushing device 104 is operating in an idle state.

Starting a step 204, the temperature detector 108 detects the temperature of various components of the crushing device 104. In one embodiment of the invention, temperature detects are installed near the bearing, shafts, and other moving parts of the crushing device 104. The detected temperature can optionally be transmitted to devices for recording and displaying the results.

Next, at a step 208, the vibration detector 116 detects the vibrations that are provided by the crushing device 104. The detected vibrations can optionally be transmitted to devices for recording and displaying the results.

Continuing to a decision step 212, a determination is made whether the vibration levels are “high.” The definition of what constitutes “high” vibration levels depends on the embodiment of the invention. In one embodiment of the invention, a high vibration level is typically between 1.5 to 2 times the normal-no fault vibration level. The vibration level could also be much higher for severe faults.

If it is determined that the vibration level is not high, the process proceeds to a decision step 216. However, if it is determined that the vibration level is high, the process proceeds to a decision step 220.

Referring again to the decision step 216, the temperature detector 108 determines whether any of the detected temperatures of the crushing device exceed a predefined threshold. If the temperature exceeds the threshold, the process proceeds to the decision step 220. However, if the temperature does not exceed the threshold, the process returns to the step 204 (discussed above). The monitoring of temperature may or not be made as an integral part of the detection system or an interconnecting monitoring device.

As discussed above, if the detected vibration level of the crushing device 104 is high (decision step 212) or the detected temperature of the crushing device 104 is high (decision step 216), the process proceeds to a decision step 220. At the step 220, the idle detector 112 is notified by the temperature detector 108 or the vibration detector 116 of the possible fault condition and the idle detector 112 determines whether the crushing device 104 is in an idle state. To detect the idle state, the idle detector 112 uses any of the methods discussed above with reference to FIG. 1. If the crushing device 104 is in an idle state, the process proceeds to a step 224, and the idle detector 112 signals the alarm 120. At this step, the alarm 120 alerts the user to the presence of a fault, e.g., high vibration or high temperature, and can also notify the user of the location of the fault. At this time, the idle detector 112 may automatically stop the operation of the crushing device 104 if so configured by the user.

Referring again to the decision step 220, if the idle detector 112 determines that the crushing device 104 is crushing material, the idle detector 112 attributes the high vibration level or high temperature level to the crushing operation, and the process returns to the step 204 (discussed above).

FIGS. 3A, 3B, 3C, 3D are each representational block diagrams of a selected type of crushing devices. FIG. 3A is a representational side elevational block diagram illustrating one embodiment of a cone crusher 300. The cone crusher 300 has a vertical shaft 304 that is used to drivingly rotate a crushing cone 308. The material to be crushed is poured between the cone crusher 300 and an outer chamber (not shown) and is crushed by the rotation of the cone crusher 300 against the outer chamber. A drive shaft 316 is connected to a hub (partially shown) rotates and drives the vertical shaft 304. A radial sensor 320 detects radial vibration signals from the drive shaft 316. An axial sensor 324 detects axial vibration signals from the drive shaft 316. A sensor 328 is used to measure vibration signals from the vertical shaft 304. In one embodiment of the invention, the sensors 320, 334, and 338 also measure temperature. The sensors 320, 324 and 328 each provide the sensed information, i.e., vibration signals or temperature, to the temperature detector 108 and/or the vibration detector 116. It is to be appreciated additional or fewer sensors could be used, and the location of the sensors can be changed.

FIG. 3B is a representational block diagram illustrating one embodiment of a roll crusher 332. The roll crusher 332 includes a first shaft 336 and a second shaft 342. A crush bearing 340 and a crush bearing 344 are mounted on the first shaft 336 and rotate about an axis of rotation that is defined by the first shaft 336. A crush bearing 348 and a crush bearing 352 are mounted on the second shaft 342 and rotate about an axis of rotation that is defined by the second shaft 342. In operation, a material is passed between the first shaft 336 and the second shaft 342 and is crushed by the crushing bearings 340, 344, 348, and 352 against an adjacent shaft. Sensors 356, 360, 364, and 368 are respectively radially located proximate to the bearings 340, 344, 348, and 352 so as to detect vibration signals and/or the temperature. It is to be appreciated, additional shafts and/or bearings could be used. The sensors 356, 360, 364, and 368 each provide the sensed information, i.e., vibration signals or temperature, to the temperature detector 108 and/or the vibration detector 116. It is also to be appreciated additional or fewer sensors could be used, and the location of the sensors can be changed.

FIG. 3C is a representational side elevational block diagram illustrating one embodiment of a jaw crusher 372. Depending on the embodiment, the jaw crusher 372 can have single or double toggle designs. As shown in FIG. 3C, the jaw crusher 372 includes a horizontal shaft 376 that rotates a plurality of bearings 380, 384, 386, and 388 that crush material against either a plate 390 or a plate 392. In one embodiment of the invention, the bearings 384 and 386 are acentrically mounted on the shaft 376. Sensors 392, 394, 396, and 398 respectively monitor the vibration and/or temperature of the bearings 380, 384, 386, and 388. It is to be appreciated, additional shafts and/or bearings could be used. The sensors 392, 394, 396, and 398 each provide the sensed information, i.e., vibration signals or temperature, to the temperature detector 108 and/or the vibration detector 116. It is also to be appreciated additional or fewer sensors could be used, and the location of the sensors can be changed.

FIG. 3D is a representational block diagram illustrating one embodiment of an impact crusher 400. The impact crusher 400 includes a rotating horizontal shaft 402 that drives bearings 408 and 410. The impact crusher 400 can have horizontal and vertical shaft designs. Materials is passed between the bearings 408 and 410 and are thrown against a plate 404. A sensor 412 and a sensor 416 are radially placed proximate to the bearings 412 and 416 and measure the vibrations and/or temperature of the bearings. It is to be appreciated, additional shafts and/or bearings could be used. The sensors 412 and 416 each provide the sensed information, i.e., vibration signals or temperature, to the temperature detector 108 and/or the vibration detector 116. It is also to be appreciated additional or fewer sensors could be used, and the location of the sensors can be changed. The cone crusher 300, the roll crusher 332, the jaw crusher 392, and the impact crusher 400 can use rolling element or hydrodynamic bearings, or combination thereof.

Advantageously, the monitoring system for the crushing device provides continuous and automatic monitoring of a crushing device. The monitoring system automatically identifies potential faults in the crushing system. The monitoring system can check for damage of roller bearings, gears, gear shim pack looseness, lack of lubrication, lubrication contamination, mechanical looseness, and an unbalanced rotors in the crushing devices. The fault monitoring can also be applied to a drive motor of the crusher.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A crushing system, comprising:
a crushing device configured to crush a material;
a detector configured to detect an idle state of the crushing device and wherein the detector is configured to determine whether the vibration signals received from the crushing device during the detected idle state indicate a fault; and
an alarm configured to signal the fault.

2. The system of claim 1, wherein the crushing device is selected from the group comprising: a cone crusher, a jaw crusher, an impact crusher, and a roll crusher.

3. The system of claim 1, wherein the detector uses the detected vibration signals so as to detect an idle state.

4. The system of claim 1, wherein the detector comprises a level indicator for indicating a height level of the material in the crushing device.

5. The system of claim 1, wherein the detector comprises a mechanical indicator switch for indicating an idle state of the crushing device.

6. The system of claim 1, wherein the detector detects a change in current or power that is provided to the crushing device so as to detect the idle state.

7. A method of monitoring a crushing device, the method comprising:
detecting an idle state of the crushing device;
detecting a vibration signals of the crushing device; and
determining, subsequent to the detection of an idle state, whether the detected vibration signals indicate a fault.

8. The method of claim 7, wherein the crushing device is selected from the group comprising: a cone crushing device, a jaw crushing device, an impact crushing device, and a roll crushing device.

9. The method of claim 7, additionally comprising detecting the presence of a material in the crushing device.

10. The method of claim 7, detecting a change in current that is provided to the crushing device so as to detect the idle state.

11. A system for monitoring a crushing device, the system comprising:
means for detecting an idle state of a crushing device;
means for detecting vibration signals from the crushing device;
means for detecting a temperature of at least one area of the crushing device
means for determining, subsequent to the detection of an idle state, whether the detected vibration level of the crushing device exceeds a threshold.

12. The system of claim 11, additionally comprising means for identifying to a user that the vibration level exceeds the threshold.

13. The system of claim 11, wherein the crushing device is selected from the group comprising: a cone crusher, a jaw crusher, an impact crusher, and a roll crusher.

14. The system of claim 11, additionally comprising means for detecting the presence of a material in the crushing device.

15. The system of claim 11, additionally comprising means for detecting a change in current that is provided to the crushing device and thereby detecting the idle state.

16. A crushing system comprising:
a crushing device configured to crush a material; and
a detector for detecting when the crushing device is in an idle state and for detecting a temperature of a selected area of crushing device; and
an alarm for identifying when the temperature exceeds a selected threshold and when the crushing device is in the idle state.

17. The system of claim 16, wherein the crushing device is selected from the group comprising: a cone crusher, a jaw crusher, an impact crusher, and a roll crusher.

18. The system of claim 16, wherein the detector comprises a level indicator for indicating a height level of the material in the crushing device.

19. The system of claim 16, wherein the detector comprises a mechanical indicator switch for indicating an idle state of the crushing device.

20. The system of claim 16, wherein the detector detects a change in current that is provided to the crushing device so as to detect the idle state.

21. A method of monitoring crushing equipment, the method comprising:
detecting an idle state of a crushing device;
detecting a temperature of at least one area of the crushing device; and
determining, subsequent to the detection of an idle state, whether the detected temperature exceeds a threshold.

22. The method of claim 21, additionally comprising identifying to a user that the temperature exceeded the threshold.

23. The method of claim 21, wherein the crushing device is selected from the group comprising: a cone crusher, a jaw crusher, an impact crusher, and a roll crusher.

24. The method of claim 21, additionally comprising detecting the presence of a material in the crushing device.

25. The method of claim 21, additionally comprising detecting a change in current that is provided to the crushing device so as to detect the idle state.

26. A system for monitoring crushing equipment, the system comprising:
means for detecting an idle state of a crushing device;
means for detecting a temperature of at least one area of the crushing device; and
means for determining, subsequent to the detection of an idle state, whether the detected temperature exceeds a threshold.

27. The system of claim 26, additionally comprising means for identifying to a user that the vibration level exceeded the threshold.

28. The system of claim 26, wherein the crushing device is selected from the group comprising: a cone crusher, a jaw crusher, an impact crusher, and a roll crusher.

29. The system of claim 26, additionally comprising means for detecting the presence of a material in the crushing device.

30. The system of claim 26, additionally comprising means for detecting a change in current that is provided to the crushing device and thereby detecting the idle state.

31. A method of monitoring crushing equipment, the method comprising:
detecting an idle state of a crushing device;
detecting a fault of the crushing device during the detected idle state; and
identifying to a user the detected fault.

32. The method of claim 31, additionally comprising detecting a temperature of at least one area of the crushing device.

33. A monitoring system, comprising:
a detector configured to detect an idle state of a crushing device and configured to detect vibration signals from the crushing device; and
an alarm configured to identify when the vibration signals identify a fault in the crushing device and when the crushing device is in the idle state.

34. The monitoring system of claim 33, wherein the detector comprises a level indicator for indicating a height level of the material in the crushing device.

35. The monitoring system of claim 33, wherein the detector comprises a mechanical indicator switch for indicating an idle state of the crushing device.

36. The monitoring system of claim 33, wherein the detector detects a change in current that is provided to the crushing device so as to detect the idle state.

37. A crushing system, comprising:
a crushing device configured to crush a material, wherein the crushing device is selected from the group comprising,: a cone crusher, a jaw crusher, an impact crusher, and a roll crusher;
a first detector configured to detect vibration signals from the crushing device and configured to identify fault conditions based upon the detected vibration signals;
a second detector configured to detect an idle state of the crushing device;
a third detector configured to detect a temperature of at least one component of the crushing device; and
an alarm for signaling the occurrence of the identified fault conditions during the detected idle state.

38. A system for monitoring a crushing device, the system comprising:
means for detecting an idle state of a crushing device;
means for detecting vibration signals from the crushing device;
means for determining, subsequent to the detection of an idle state, whether the detected vibration level of the crushing device exceeds a threshold.

39. The system of claim 38, additionally comprising means for identifying to a user that the vibration level exceeds the threshold.

40. The system of claim 38, wherein the crushing device is selected from the group comprising: a cone crusher, a jaw crusher, an impact crusher, and a roll crusher.

41. The system of claim 38, additionally comprising means for detecting the presence of a material in the crushing device.

42. The system of claim 38, additionally comprising means for detecting a change in current that is provided to the crushing device and thereby detecting the idle state.
